(19) United States
(12) Patent Application Publication
(10) Pub. No.: US 2004/0001984 A1
(43) Pub. Date: Jan. 1, 2004

(54) Fuel cell cooling system for low coolant flow rate

(76) Inventor: Julio Alva, Brampton (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/184,079

(22) Filed: Jun. 28, 2002

(51) Int. Cl. H01M 8/04

(52) U.S. Cl. 429/26; 429/34; 429/24; 429/13

(57) ABSTRACT

A fuel cell cooling system for supplying coolant to a fuel cell, and a method of operating a fuel cell cooling system to supply coolant to a fuel cell. The fuel cell cooling system has a first coolant circulation loop for supplying coolant to a fuel cell and a second coolant circulation loop intersecting the first coolant loop. Coolant from the first coolant circulation loop is supplied to the fuel cell. Coolant from the second coolant circulation loop is supplied to the first coolant circulation loop to mix the coolant in the first and second circulation loops and to effect turbulence in the coolant flow.

### FIELD OF THE INVENTION

The present invention relates generally to a fuel cell cooling system. More particularly, the present invention relates to a fuel cell cooling system for low flow rate of coolant

### BACKGROUND OF THE INVENTION

Fuel cells have been proposed as a clean, efficient and environmentally friendly source of power, which can be utilized for various applications. A fuel cell is an electrochemical device that produces an electromotive force by bringing the fuel (typically hydrogen) and an oxidant (typically air) into contact with two suitable electrodes and an electrolyte. A fuel, such as hydrogen gas, for example, is introduced at a first electrode, i.e. the anode, where it reacts electrochemically in the presence of the electrolyte to produce electrons and cations. The electrons are conducted from the anode to a second electrode, i.e. the cathode, through an electrical circuit connected between the electrodes. Cations pass through the electrolyte to the cathode. Simultaneously, an oxidant, such as oxygen gas or air is introduced to the cathode where the oxidant reacts electrochemically in presence of the electrolyte and catalyst, producing anions and consuming the electrons circulated through the electrical circuit; the cations are consumed at the second electrode. The anions formed at the second electrode or cathode react with the cations to form a reaction product. The anode may alternatively be referred to as a fuel or oxidizing electrode, and the cathode may alternatively be referred to as an oxidant or reducing electrode. The half-cell reactions at the two electrodes are, respectively, as follows:

$${H}_{2} -> 2 {H}^{+} + 2 {e}^{-} \qquad \frac{1}{2} {O}^{2} + 2 {H}^{+} + 2 {e}^{-} -> {H}_{2} O$$

The external electrical circuit withdraws electrical current and thus receives electrical power from the fuel cell. The overall fuel cell reaction produces electrical energy as shown by the sum of the separate half-cell reactions written above. Water and heat are typical by-products of the reaction. Accordingly, the use of fuel cells in power generation offers potential environmental benefits compared with power generation from combustion of fossil fuels or by nuclear activity. Some examples of applications are distributed residential power generation and automotive power systems to reduce emission levels.

In practice, fuel cells are not operated as single units. Rather fuel cells are connected in series, stacked one on top of the other, or placed side-by-side, to form what is usually referred to as a fuel cell stack. The fuel, oxidant and coolant are supplied through respective delivery subsystems to the fuel cell stack. Also within the stack are current collectors, cell-to-cell seals and insulation, with required piping and instrumentation provided externally to the fuel cell stack.

As fuel cell reactions are exothermic, heat generated within the fuel cell stack has to be dissipated to ensure that the fuel cells operate under optimum temperature range. One of the commonly used methods of cooling a fuel cell stack is providing coolant flow passages within the fuel cell stack having a coolant inlet and a coolant outlet, and running liquid coolant through the fuel cell stack. A coolant circulation loop is typically included, which includes a circulation pump and a heat exchanger. The circulation pump supplies the coolant to the coolant inlet of the fuel cell stack and draws the coolant from the coolant outlet. The coolant absorbs heat generated in the fuel cell stack as it flows through the fuel cell stack. Outside the stack, the coolant is cooled by a heat exchanger to within a predetermined temperature range. Such arrangements can be found in U.S. patent application Ser. No. Publication 2001/0049042, European Patent Application EP 1187242, U.S. Pat. No. 4,824,740 and Japanese Laid-open Publication JP 2001035519. Typical coolant includes deionized water, pure water, any non-conductive water, ethylene glycol, the mixture thereof, etc.

The heat exchanger in the coolant circulation loop can be a radiator, as disclosed in U.S. Ser. No.2001/0049042 and EP 1187242. Alternatively, the heat exchanger can be an isolation heat exchanger in which two fluids exchange heat in a non-mixing manner. In this case, another coolant circulation loop is provided. This arrangement is disclosed in U.S. patent application Ser. Publications No. 2002/0031693 and U.S. Ser. No.2002/0037447 and U.S. Pat. No. 6,013,385. Depending on the system configuration and fuel cell power capacity, a heater may be provided in the coolant circulation loop either downstream or upstream of the heat exchanger to heat the coolant, thereby maintaining the temperature of the coolant within a desired range.

However, the aforementioned coolant systems are less efficient when used for fuel cell stacks having low power output and hence operating under low coolant flow rate, such as less than 1 liter per minute, for example 20 centiliter/min, or even in the order of milliliters per minute. When the coolant flow rate in the coolant circulation loop is low, relatively greater heat loss occurs in conduits or pipes forming the coolant circulation loop. Low coolant flow rate also results in poor heat exchange efficiency within the heater and heat exchanger. Therefore, in conventional cooling systems, such as those mentioned above, it is difficult to maintain the temperature of the coolant within an optimum range, which in turns affects the efficiency of the fuel cell stack.

There remains a need for a fuel cell cooling system that can offer higher efficiency of thermal management of coolant and hence better control of temperatures of coolant under low coolant flow rate.

### SUMMARY OF THE INVENTION

An object of one aspect of the present invention is to provide an improved fuel cell cooling system.

In accordance with one aspect of the present invention, there is provided a fuel cell cooling system comprising: (a) a first coolant circulation loop for supplying a coolant to a fuel cell, and (b) a second coolant circulation loop for improving heat exchange in the coolant. The first coolant circulation loop has a first circulation means for circulating the coolant through the fuel cell. The second circulation loop has a second circulation means for circulating the coolant through the second circulation loop. The first and second coolant circulation loops intersect to mix the coolant in the first and second coolant circulation loops and to effect turbulence in the coolant flow.

An object of a second aspect of the present invention is to provide a method of operating a fuel cell cooling system.

In accordance with a second aspect of the present invention, there is provided a method of operating a fuel cell cooling system to supply coolant to a fuel cell. The fuel cell cooling system has a first coolant circulation loop for supplying coolant to a fuel cell and a second coolant circulation loop intersecting the first coolant loop. The method comprises: (a) supplying coolant from the first coolant circulation loop to the fuel cell; and, (b) supplying coolant from the second coolant circulation loop to the first coolant circulation loop to mix the coolant in the first and second circulation loops and to effect turbulence in the coolant flow.

The present invention has many advantages over the prior art when employed in fuel cell cooling systems having low flow rates. Increasing the turbulence of the coolant by mixing coolant in the first and second coolant circulation loops increases heat exchange efficiency in the coolant circulation loop. This in turn renders better control of the temperature of the coolant flowing through the fuel cell. Therefore, fuel cell is ensured to operate under optimum temperature and hence it is operating more efficiently.

Additionally, while the invention is described and claimed as providing a “cooling system”, more generally the system can provide both cooling and heating of the fuel cell 10. The coolant is thus more generally a heat transfer fluid. References to “cooling” and related terms should be construed accordingly.

### BRIEF DESCRIPTION OF THE DRAWINGS

For a better understanding of the present invention, and to show more clearly how it may be carried into effect, reference will now be made, by way of example, to the accompanying drawings, which show a preferred embodiment of the present invention and in which:

FIG. 1 illustrates a schematic flow diagram of a first embodiment of a fuel cell cooling system according to the present invention;

FIG. 2 illustrates a schematic flow diagram of a second embodiment of the fuel cell cooling system according to the present invention; and,

FIG. 3 illustrates a schematic flow diagram of a third embodiment of the fuel cell cooling system according to the present invention.

### DETAILED DESCRIPTION OF THE PREFERRED EMBODIMENTS

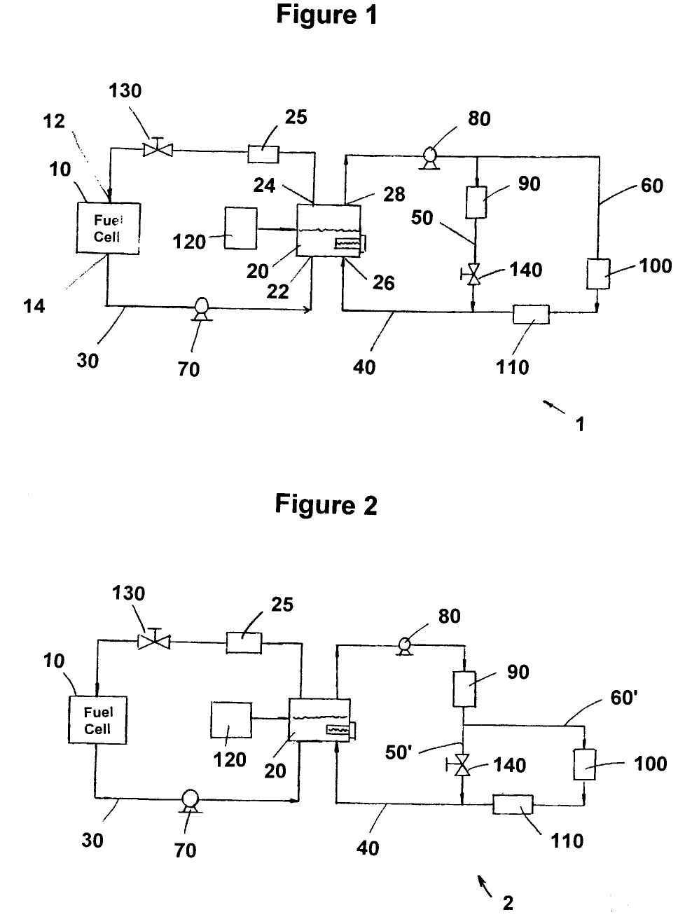

Referring to FIG. 1, this shows a schematic flow diagram of a first embodiment of a fuel cell cooling system 1 according to the present invention. The fuel cell cooling system 1 generally comprises a fuel cell 10, a first coolant circulation loop 30 and a second coolant circulation loop 40. In known manner, the fuel cell 10 has a coolant inlet 12 and a coolant outlet 14 so that coolant in the first coolant circulation loop 30 flows through the fuel cell 10 to absorb heat generated in the fuel cell reaction. It is to be understood that in the present invention, “fuel cell” is used to indicate a fuel cell stack comprising a plurality of fuel cells or just a single fuel cell. In addition, the present invention is applicable to any type of fuel cell.

As shown in FIG. 1, the first coolant circulation loop 30 comprises a first circulation pump 70, a heater 20, a first heat exchanger 25 and a first valve 130. The heater 20, for example an electric heater, receives coolant from a coolant source 120, such as a coolant storage tank. As indicated schematically, the heater 20 can be in the form of a tank or enclosed vessel, with appropriate inlets and outlets and a heating element. The heater 20 has a first inlet 22 and a first outlet 24 so that coolant in the first coolant circulation loop 30 flows through the heater 20 via the first inlet 22 and the first outlet 24. The first circulation pump 70 circulates the coolant to flow through the fuel cell 10, the heater 20 and the first heat exchanger 25. The first valve 130 serves to regulate the flow of the coolant supplied to the fuel cell 10.

As in known in the art, the temperature of the coolant needs to be maintained in a desired range in order to keep the fuel cell 10 operating within an optimal temperature range. When the fuel cell cooling system 1 is operating under low coolant flow rate, heat loss in the conduits or pipes is relatively great. In order to prevent coolant temperature from becoming too low when the coolant is circulated back to the fuel cell 10, the heater 20 is provided. In addition, during initial start-up of the fuel cell 10, coolant is at a relatively low temperature. The heater 20 helps to heat up the coolant during start-up to bring the coolant to desired temperature more rapidly. The first heat exchanger 25 is disposed downstream of the heater 20 to regulate the temperature of the coolant supplied back to the fuel cell 10, for example, to lower the temperature of the overheated coolant from the heater 20. Under very low flow rates, for example, in the order of milliliters per minute, the first heat exchanger 25 may be omitted as the heat loss in conduits or pipes is great.

It is to be noted that the circulation pump 70 and the first valve 130 can be placed at various positions in the first coolant circulation loop 30. For example, the pump 70 or the first valve 130 can be placed either downstream or upstream of the fuel cell 10 along the circulation direction of the coolant. The first heat exchanger 25 may be a radiator, or an isolation liquid-liquid heat exchanger.

Still referring to FIG. 1, in the first embodiment of the present invention, the second coolant circulation loop 40 comprises a second coolant circulation pump 80, a first flow branch 50 and a second flow branch 60. The pump 80 circulates the coolant from the heater 20 to the two branches 50, 60 and returns the coolant to the heater 20. A second heat exchanger 90 and a second valve 140 are disposed in the first branch 50 while a third heat exchanger 100 and a filter 110 are disposed in the second branch 60. The heater 20 has a second inlet 26 and a second outlet 28 so that coolant in the second coolant circulation loop 40 flows through the heater 20 via the second inlet 26 and second outlet 28. Coolant in the first coolant circulation loop 30 and coolant in the second coolant circulation loop 40 mix within the heater 20. The second circulation pump 80 operates at a higher flow rate than the first circulation pump 70. Consequently the flow rate in the second coolant circulation loop 40 is higher than that in the first coolant circulation loop 30. As a result, greater turbulence of flow is obtained within the heater 20 compared with the case when only a low flow rate of coolant in the first coolant circulation loop 30 flows through the heater 20. This in turn provides higher heat transfer efficiency and hence the coolant in the first coolant circulation loop 30 is more effectively heated within the heater 20.

In the first branch 50, the second heat exchanger 90 regulates the temperature of the coolant from the heater 20. The second valve 140 regulates the flow rate of the coolant in the first branch 50 and hence the portion of the coolant flowing along the first branch 50. In this embodiment, a second branch 60 is provided for purifying the coolant. As in known in the art, as coolant flows along conduits and pipes, it picks up impurities particles and ions. To keep the coolant non-conductive so that the coolant does not short the fuel cell 10 when flowing therethrough, a filter 110 is usually provided to filter out the impurities and ions. This is particularly useful when deionized water is used as the coolant. Depending on the type of coolant, the filter may be of different type or simply omitted. A third heat exchanger 100 is provided in the second branch 60 to regulate the temperature of the coolant. A valve is not needed in the second branch 60, as the portion of coolant flowing through the second branch 60 can be adjusted by the second valve 140.

Now referring to FIG. 2, this shows a schematic flow diagram of a fuel cell cooling system 2 according to a second embodiment of the present invention. For simplicity, the elements in this embodiment that are identical or similar to those in the first embodiment are indicated with same reference numbers and for brevity, the description of these elements is not repeated.

In this embodiment, the second branch 60′ of the second coolant circulation loop 40 originates downstream of the second heat exchanger 90 while in the first embodiment, the second branch 60 originates from a position upstream of the second heat exchanger 90. Thus the first branch 50′ comprises only the second valve 140 to regulate the flow rate therethrough. The second branch 60′ still comprises the third heat exchanger 100 and the filter 110. The second heat exchanger 90 may also be disposed downstream of the second valve 140 and the filter 110. In the second embodiment, the second coolant circulation pump 80 operates at higher flow rate than the first coolant circulation pump 70 to create greater turbulence within the heater 20, and hence higher heat transfer efficiency.

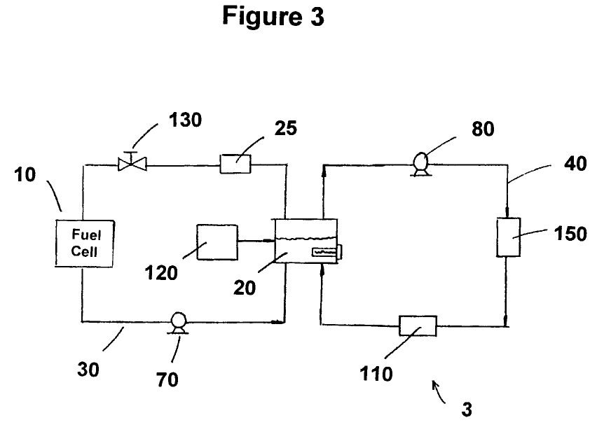

Now referring to FIG. 3, there is illustrated, in a schematic flow diagram, a fuel cell cooling system 3 according to a third embodiment of the present invention. Again, the elements in this embodiment that are identical or similar to those in the above embodiments are indicated with same reference numbers and for brevity, the description of these elements is not repeated.

The third embodiment shows a simplified design. In this embodiment, the second coolant circulation loop 40 comprises a second circulation pump 80, a heat exchanger 150 and a filter 110. As in the above two embodiments, the second circulation pump 80 operates at a higher flow rate than the first circulation pump 70 to create turbulence within the heater 20. In this embodiment, the two branches of the second coolant circulation loop 40 are combined. It is to be noted that depending on the type of coolant used in the present invention, the filter 110 is not essential and hence can be omitted.

The coolant used in the present invention can be any type of coolant commonly used in the art. When deionized water is used, it is preferred to provide the filter 1 10. In case the filter 110 is omitted, the second branch 60, 60′ of the second coolant circulation loop 40 in the first and second embodiments can be omitted. Hence, the first and second embodiments are simplified to the configuration of the third embodiment with the filter 110 omitted.

It is to be understood that the first, second and third heat exchangers 25, 90, 100 in the first and second embodiment, and the heat exchanger 150 in the third embodiment can be any type of heat exchanger known in the art, such as radiator, or isolation liquid-liquid heat exchanger. When isolation liquid-liquid heat exchangers are used in the present invention, a separate coolant and associated cooling loop (not shown) have to be provided for each isolation heat exchanger in known manner.

The first and second circulation pumps 70, 80 can be any type of pump commonly used. Preferably, at least the speed of the second circulation pump 80 is variable. More preferably, the second circulation pump 80 can operate at a higher flow rate than the first circulation pump 70.

It is also to be understood that, in known manner, various sensors and/or transmitters can be provided for measuring parameters of the coolant, such as temperature, pressure, flow rate, etc. The measured parameters can be sent to a processor (not shown) which in turn controls the operation of the heater 20, the first and second pumps 70, 80, and the heat exchangers 25, 90, 100 as well as the heater 20. For example, sensors or transmitters can be provided adjacent the coolant inlet and outlet of the fuel cell 15 to monitor the temperature of the coolant, and hence the amount of heat removed from the fuel cell 15. Similarly, sensors may also be provided adjacent the inlets and outlets of the heater 20 to monitor the temperature of the coolant, and hence the heating efficiency. The measured data is then sent to the processor for analysis. Then the process will control the operation of the components, such as increasing or decreasing the speed of the first or second pump, increasing or decreasing fan speed of radiators, if radiators are used as heat exchangers, increasing or decreasing heating, etc.

It should be appreciated that the spirit of the present invention is to achieve better control of the temperature of the coolant flowing through the fuel cell by increasing heat exchange efficiency in the coolant circulation loop. The increased heat exchange efficiency is obtained by increasing the turbulence by mixing coolant in the first and second coolant circulation loops 30 and 40. It is not necessary for the mixing of the coolant to occur within the heater 20, although this is preferred. But rather, the coolant in the two loops can mix at different positions, upstream of downstream of the heater 20.

It should also be appreciated that the present invention is not limited to the embodiment disclosed herein. It can be anticipated that those having ordinary skills in the art can make various modifications to the embodiments disclosed herein without departing from the fair meaning or the proper scope of the accompanying claims. For example, the number and arrangement of components in the system might be different, different elements might be used to achieve the same specific function. However, these modifications should be considered to fall within the protected scope of the invention as defined in the following claims.

1. A fuel cell cooling system, comprising:
(a) a first coolant circulation loop for supplying a coolant to a fuel cell, the first coolant circulation loop having a first circulation means for circulating the coolant through the fuel cell; and
(b) a second coolant circulation loop for improving heat exchange in the coolant, the second circulation loop having a second circulation means for circulating the coolant through the second circulation loop;
wherein the first and second coolant circulation loops intersect to mix the coolant in the first and second coolant circulation loops and to effect turbulence in the coolant flow.

2. A fuel cell cooling system as claimed in claim 1, wherein the coolant in the second coolant circulation loop has a higher flow rate than the coolant in the first coolant circulation loop.

3. A fuel cell cooling system as claimed in claim 2, wherein the first coolant circulation loop and the second coolant circulation loop intersect at a mixing device and wherein the coolant in the first and second coolant circulation loops mix in the mixing device.

4. A fuel cell cooling system as claimed in claim 3, wherein the mixing device includes a heat exchanging means for adjusting the temperature of the coolant in the mixing device.

5. A fuel cell cooling system as claimed in claim 4, wherein the heat exchanging means is a heater for heating the coolant in the mixing device.

6. A fuel cell cooling system as claimed in claim 5, wherein the second coolant circulation loop further includes a first branch and a second branch.

7. A fuel cell cooling system as claimed in claim 6, wherein one of the first and second branches of the second coolant circulation loop comprises a filter for purifying the coolant.

8. A fuel cell cooling system as claimed in claim 7, wherein the filter is an ion filter for deionizing the coolant.

9. A fuel cell cooling system as claimed in claim 8, wherein at least one of the first coolant circulation loop, the first branch of the second coolant circulation loop and the second branch of the second coolant circulation loop includes a heat exchanger for adjusting the temperature of the coolant.

10. A fuel cell cooling system as claimed in claim 9, wherein at least one of the first and second coolant circulation means is a pump having variable speed.

11. A fuel cell cooling system as claimed in claim 10, wherein at least one of the first and second coolant circulation loops has a flow regulating means for regulating the flow rate in the respective loop.

12. A fuel cell cooling system as claimed in claim 11, further comprising a plurality of temperature sensors for detecting the temperature of the coolant supplied to and exiting from the fuel cell and the temperature of the coolant in the mixing device.

13. A fuel cell cooling system as claimed in claim 12, further comprising a controller for controlling the heater, heat exchanger and the flow regulating means in response to the detected temperatures by the temperature sensors.

14. A method of operating a fuel cell cooling system to supply coolant to a fuel cell, the fuel cell cooling system having a first coolant circulation loop for supplying coolant to a fuel cell and a second coolant circulation loop intersecting the first coolant loop, the method comprising:
a) supplying coolant from the first coolant circulation loop to the fuel cell; and,
b) supplying coolant from the second coolant circulation loop to the first coolant circulation loop to mix the coolant in the first and second circulation loops and to effect turbulence in the coolant flow.

15. A method of operating a fuel cell cooling system as claimed in claim 14, wherein the coolant in the second circulation loop has a higher flow rate than the coolant in the first circulation loop.

16. A method of operating a fuel cell cooling system as claimed in claim 15, wherein the fuel cell cooling system comprises a mixing device for mixing the coolant from the first and second coolant circulation loops in step (b).

17. A method of operating a fuel cell cooling system as claimed in claim 16, further comprising adjusting the temperature of the coolant in the mixing device.

18. A method of operating a fuel cell cooling system as claimed in claim 17 further comprising filtering the coolant in the second circulation loop.

19. A method of operating a fuel cell cooling system as claimed in claim 17, wherein the fuel cell cooling system comprises an ion filter for filtering and deionizing the coolant in the second circulation loop.

20. A method of operating a fuel cell cooling system as claimed in claim 19, further comprising adjusting the temperature of the coolant in at least one of the first coolant circulation loop and the second coolant circulation loop.

21. A method of operating a fuel cell cooling system as claimed in claim 20, further comprising regulating a flow rate of the coolant in at least one of the first and second coolant circulation loops.

22. A method of operating a fuel cell cooling system as claimed in claim 21, further comprising detecting the temperature of the coolant supplied to and exiting from the fuel cell and the temperature of the coolant in the mixing device.

23. A method of operating a fuel cell cooling system as claimed in claim 22, further comprising controlling, based on the temperature of the coolant supplied to and exiting from the fuel cell and the temperature of the coolant in the mixing device, the steps of regulating a flow rate of the coolant in at least one of the first and second coolant circulation loops, adjusting the temperature of the coolant in the mixing device, and adjusting the temperature of the coolant in at least one of the first coolant circulation loop and the second coolant circulation loops.
